(19) United States
(12) Patent Application Publication
(10) Pub. No.: US 2014/0172517 A1
(43) Pub. Date: Jun. 19, 2014

(54) RANDOM SAMPLE ELECTIONS

(71) Applicant: David Chaum, Sherman Oak, CA (US)

(72) Inventor: David Chaum, Sherman Oak, CA (US)

(21) Appl. No.: 14/237,991

(22) PCT Filed: Jun. 18, 2012
(86) PCT No.: PCT/US12/00287

§ 371 Date: Feb. 10, 2014

Related U.S. Application Data
(60) Provisional application No. 61/498,597, filed on Jun. 19, 2011.

(51) Int. Cl. G07C 13/00

(52) U.S. Cl. CPC G07C 13/00
USPC 705/12

(57) ABSTRACT

A novel method allows a random sample of a large population of voters to cast votes and for both the unpredictability/un-manipulability of the sample selection and the integrity of the tally to be verified by any interested parties using public information. The problem of vote selling is addressed. Also, a variant allows voters to remain substantially anonymous.

### BACKGROUND OF THE INVENTION

1. Field of the Invention

The invention is in the general field of polling, and more specifically where not all eligible persons are per poll.

2. Description of Prior Art

The present application claims priority from United States Provisional Applications, by the present applicant, titled “Statistical Elections,” USPTO 61/498597, filed 19 Jun., 2011.

Commercial and social advantage may result from a technique whereby a population can be polled, whether or not binding, with a result that is believed more representative and/or convincing than what is achieved by elections today.

### BRIEF DESCRIPTION OF THE DRAWING FIGURES

FIG. 1 shows a combination flowchart and cryptographic protocol diagram of an exemplary embodiment of an overall voting system aspect in accordance with the teachings the invention.

FIG. 2 shows a protocol diagram of an exemplary cryptographic commitment system in accordance with the teachings of the invention.

### BRIEF SUMMARY OF THE INVENTION

This section introduces some of the inventive concepts in a way that will readily be appreciated, but that may make significant simplifications and omissions for clarity and should accordingly not be taken to limit their scope in any way; the next section presents more detailed descriptions.

Random-sample election techniques can it is believed further advantageously have a cost for a large population that may be several orders of magnitude less than that of conducting a conventional election. The properties that are believed achievable in some example random-sample elections may be summarized as follows:
Only votes from randomly selected voters are counted.
Integrity of the published tally of votes cast is cryptographically proved.
Vote buying and other “improper influence” of voters is difficult or even impractical.
Ballot secrecy violation requires collusion/compromise of election authority or the underlying cryptography.
Voters can optionally be compensated for valid participation (even based on a test to determine that they made consistent answers to the questions).
Voters can optionally remain substantially anonymous from all but the election authority.

### GENERAL DESCRIPTION

A general description of an exemplary embodiment will be provided as will be appreciated without limitation and making certain simplifications for clarity as will be understood.

A pre-agreed public random process, such as stock-market closing data, determines which voters are to receive ballots that will be counted. Although the voters are publicly verifiable as selected by the results of the random process, their identity is hidden at least initially. Those ballots sent to the randomly selected voters will be known to those voters to be at least very likely counted, as a consequence of a public cryptographic proof. Anyone can, however, request a ballot that will not be counted. Because such requested ballots will only be distinguishable by the requesting voter, they can be sold to vote buyers and are believed more likely to be sold than the countable ballots.

The identity of all voters may be made public once voting is over. Alternatively, a number of “verifiers” may be selected at random, provided with instructions, and only later would the identity of verifiers be made public. Each verifier is provided the identity of a different one of the voters and instructed to contact that voter and ensure that the voter has in fact cast the ballot—and to raise an alarm otherwise. Voters may obtain a code, also known but only in random parts to the verifier, so that the verifier can be convinced that the voter did in fact receive a ballot and verifiers can provide evidence of successful verification they performed. Verifiers may be employed for counted and even uncounted voters. Verifiers, as well as optionally voters who answer verifier queries, may collect rewards. Of course if ballots are sent “signature required,” then the authority has some recourse against a voter falsely crying foul.

The participants in a simplified example are the Election Authority and

Three classes of members of the public:
(1) randomly-selected voters whose votes will be counted;
(2) self-selected voters whose votes will not be counted; and
(3) optionally, randomly selected verifiers who do not vote but rather check that a corresponding voter did participate.

### DETAILED DESCRIPTION OF PREFERRED EMBODIMENTS

Detailed descriptions are presented here of various sufficient to allow those of skill in the art to use the exemplary preferred embodiments of the inventive concepts.

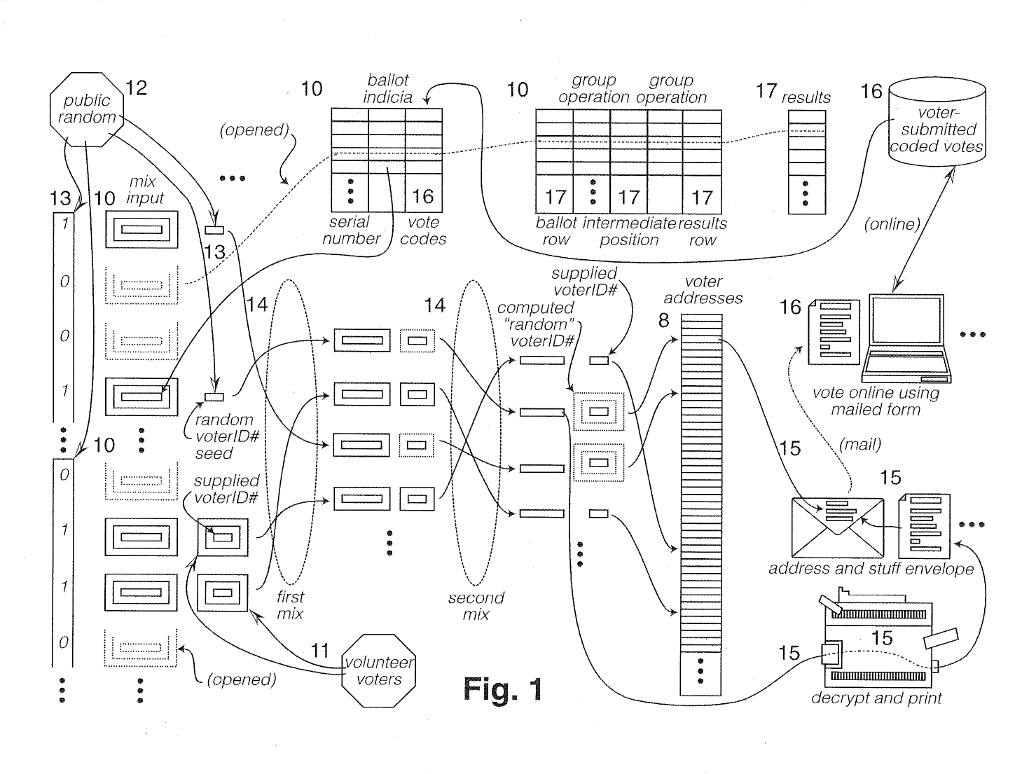

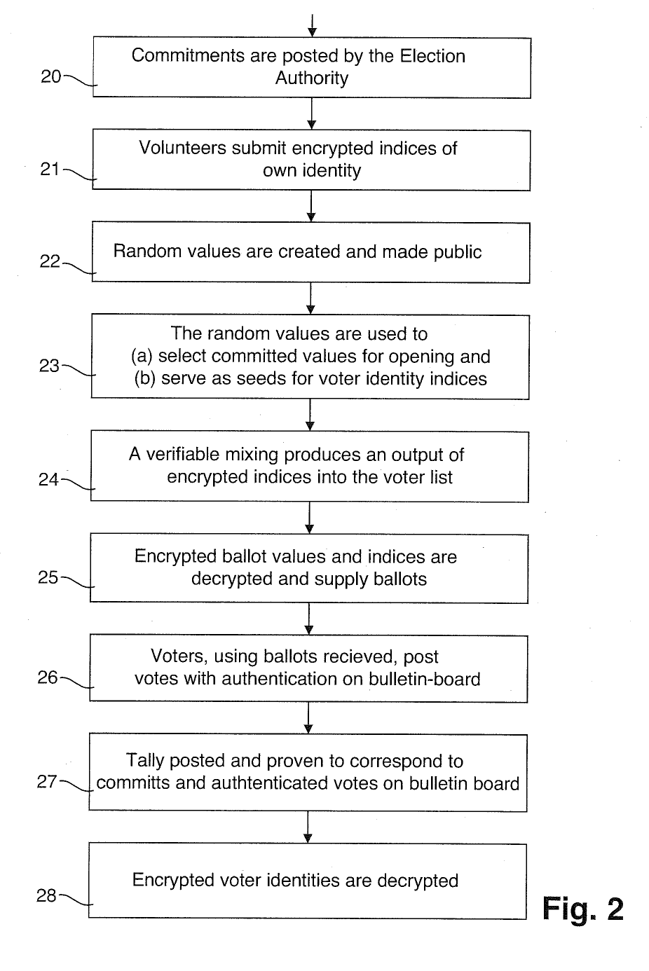

Turning now to FIG. 1, a detailed combination cryptographic protocol, functional, flowchart and block diagram of a overall exemplary random-sample voting process will be provided. A random-sample election can be conducted in nine steps as indicated in FIG. 1 by the step numbers and as will also be further described with reference to FIG. 2.

Referring now to step 10, commitments are posted by the election administrator defining: (a) the countable ballots, (b) the uncounted ballots, and (c) combined tabulation tables for both types of ballots.

More particularly, encrypted values sometimes called “commitments” are made public, such as by posting online, for instance, replicated and/or in a digitally signed form.

Each countable and uncountable ballot entry, shown arrayed vertically, consists in the example of a pair made up of two components. The first component is of the same type, whereas the second component differs for the countable and uncountable ballots. The first component, in the example, is a so-called mix input item sometimes referred to as an “onion.” It is a nested or iterated layering of public key encryption, as is known, with what will be called the “payload” at its innermost core being the ballot indicia from the combined tabulation tables to be described. The second component, continuing the example, is for the uncountable ballots, supplied in step 11 to be described, and for the countable ballots, as described in step 12.

Some combined tabulation table columns include commitments and other columns are empty and will be filled later. The tables relate to what has been called a “voter verifiable” or sometimes “end-to-end” election system, such as those previously disclosed by the present applicant under the rubric “Punchscan” or “Scantegrity,” such as have been used in binding elections. The example chosen for clarity is like that of Punchscan as used by Scantegrity, where there are three tables, shown left to right, as will be understood and familiar. (a) serial numbers, “indicia” to be printed on ballot, and the corresponding “vote codes”; (b) a pointer to the ballot row, the group operation relating the ballot row entry to the intermediate position entry, a second group operation relating the intermediate position to the row pointer for the results row; and (c) the results column The rows of the second and third tables are independently randomly permuted. Initially the vote codes, ballot row and results row pointer, and results columns are empty; the other columns are filled with commits.

One example way, described here for clarity but without limitation, to keep the ballots submitted by volunteers from having their votes included in the tally is for the corresponding “results row” entries already described to be pre-filled for these ballots with an indication that the vote will not be counted.

Referring to step 11, volunteers submit multiply-encrypted values with a so-called “payload” or here “seed” that will result in their own address being selected.

More particularly, each volunteer allowed may provide a mix input, much as already described for the first components, but with a payload that is an “encrypted” index into the list of voter addresses, to be described further with reference to steps 15 and 18.

Referring to step 12, “Public random” values are created in a pre-agreed manner, such as a cryptographic hash of certain stock market closing data, that should be unpredictable earlier than the completion of steps 10 and 11.

More particularly, such public random values are know and used, for instance, in lotteries and in voter-verifiable election systems more generally. Prior to a certain time, it is believed infeasible to predict the values or even some functions of the values.

Referring to step 13, the random values from step 12 are used: (a) to select which committed values from step 11 are to be opened; and (b) as random seeds for cryptographically-generated voter identity indexes. The random seeds are processed as the constructed second components are, with the result believed hard to predict. When a random value is processed through a mix that performs operations that would result in successive layers of encryption being stripped off (had they been applied in the first place), as will be understood by one of skill in the cryptographic protocol art, what results is a number (from the same range as can be generated from a user-constructed mix input), which can map nearly uniformly to a user identity or address. Typically, the results at each stage of processing through the mix are “restricted,” such as by truncation of enough bits, so that reverse-engineering the mapping from input to output becomes computationally infeasible.

More particularly, by processing the random seeds as if they were onions, by what may in effect be in some examples application of one or more digital signatures, the resulting value is hard to predict by those without the signing keys. This will also be further described with reference to step 14.

Also, in the present example, some such values are used to determine which of the committed values from step 10 already described are to be decrypted in a publicly verifiable manner, referred to here as “opened.” This is a known use and in the example includes a random selection of pairs and the rows of the voter-verifiable election tables that match the pairs in ballot indicia, as already mentioned as included in the pairs of the first table. Such opening of randomly selected rows in the tables is known to provide a kind of audit of whether the table content is correctly formed, as will be understood.

Referring to step 14, a verifiable mix cascade is conducted, establishing that the batch of input pairs consisting of both types (random voter identities and submitted voter identities) are successively decrypted and mixed to produce an output batch of encrypted indices into the voter address list.

More particularly, the mix in the example is shown as what was called a “cascade” when the notion of mixing was first disclosed, in “Untraceable electronic mail, return addresses, and digital pseudonyms,” Communications of the ACM, Volume 24, Issue 2, Feb. 1981, by the present applicant. Verifiability may be obtained by various interactive or non-interactive cryptographic proof techniques, as are known in an extensive literature tracing back, for instance, to early results presented by Sako and Kilian in “Receipt-free mix-type voting scheme,” Advances in Cryptology-EUROCRYPT '95, Springer-Verlag, 1995. Parallel application of a protocol, in what has been called “coordinated instances,” allows the components of a pair to be treated in the same or in a different manner, but for the association of the components to be maintained, as will be understood.

It will however be noted that in the present example system two different types of second-component items are mixed: random values and prepared mix input items. Processing of the latter yields the known decryption. Processing of the former, however, may be regarded as the nested or iterated application of digital signatures. The result is believed mainly unpredictable without the signing keys. In the present example, the final signing is not applied or a committed key is not revealed that compresses the values to the range of valid indices to the voter address list, as will also be further described with reference to step 18.

Referring to step 15, the encrypted ballot values are decrypted from the mix output batch and printed and mailed to the corresponding voter address found by indexing the table of voter addresses.

More particularly, the final second components of the final mix batch are used, as has been mentioned already with reference to step 14, to select respective voter addresses from the list of such addresses shown, as mentioned as will be further described with reference to step 18. The paired vote ballot indicia, also not revealed in cleartext, is also decrypted. Thus, pairs of ballot indicia and voter address are determined by the devices/system called out as “decrypt and print” in the figure. The result is printed material, in the example, including a ballot with the indicia, not visible from the outside, and the address visible from the outside. This may be accomplished by conventional means, such as printing a ballot form and stuffing it in an envelope with the delivery address applied to it. These addressed items are delivered to voters, for instance, such as by being mailed or couriered with or without tracking or signature required.

Referring to step 16, voters cast ballots for instance online using the mail they receive, which results in coded votes on an electronic bulletin board.

More particularly, the voter provides the codes through a web browser or other software application. It is also believed desirable that the voter checks that the codes are properly posted. The so-called electronic “bulletin board” system is well-known for such public and verifiable posting, as evidenced by the extensive literature on the subject. Various improvements to these techniques by the present applicant are disclosed in co-pending applications.

Referring to step 17, the tally is posted and proven to correspond to the published data and coded votes on the bulletin board. Votes for uncounted ballots will not yield votes, but may be stopped from being counted, such as by the pre-filled results rows entries mentioned already.

More particularly, various voter-verifiable techniques are known; however, the particular example tables shown will be described for clarity. First the results and intermediate position columns are populated (they were initially empty as mentioned earlier). Then a later public random value, such as described with reference to step 12, but where the unpredictability begins after the population mentioned, may be used. The random values determine which of the ballot row and results row pointer is to be revealed for each respective row, in some example audit schemes. Other audit schemes being well known in the cryptographic election integrity art.

Referring to step 18, the encrypted indices posted in step 14 are decrypted without regard for whether their votes would be counted or not.

More particularly, at a stage that is believed desirable later than the bulletin-board is populated or after the verifiability of the election, the encryption of the voter address may be revealed in some examples for auditing. Other types of auditing, not requiring the voter identities to be made public, will also be further described later.

Turning now to FIG. 2, a flowchart in accordance with the teachings of the present invention will be described in detail. Each of the nine steps already described with reference to FIG. 1 are summarized in the flowchart. The protocol described is somewhat more generic than the very concrete protocol description presented with reference to FIG. 1, as will be appreciated, was for clarity. In particular, for instance, the box for step 20 indicates only some form of commitment being made by the Election Authority, which may be comprised of one organization/individual and/or a quorum of organizations/individuals or a more complex structuring of participants, as are known in some cryptographic protocol settings.

As another example, the box for step 21 calls out voter identification and not address, as other procedures for voters to obtain ballots are anticipated, such as, without limitation, by in person visit or online or various combinations of techniques.

Boxes for steps 22 and 23 correspond to the steps described but in less detailed and more generic language.

The box for step (4) as yet another example calls for a verifiable “mixing,” being more generally whatever cryptographic protocol, no matter how it works, accomplishing the result so hiding the input and output correspondence.

The box of step 25, as still another example, calls out the “supply” of ballots, more generally, rather than the particular steps of printing and mailing ballot forms.

The box of step 26, as yet still another example, calls for voters posting votes with authentication, more generally than using coded votes.

The box of step 27, as yet again another example, calls for a generic cryptographic election verification process of whatever type.

And finally, the box of step 28, as still again another example, refers to voter identity information more generally as contrasted with the more specific voter addresses.

While these descriptions of the present invention have been given as examples, it will be appreciated by those of ordinary skill in the art that various modifications, alternate configurations and equivalents may be employed without departing from the spirit and scope of the present invention.

All manner of variations, generalizations and extensions are anticipated. As just one example, each verifier is provided with a voter identity and each voter optionally with a confirmation code. The verifier contacts the voter and obtains the confirmation code. A random selection of the digits of the confirmation code are provided to the verifier along with the voter identity, so that the verifier can check the validity of the confirmation code and the voter cannot, at least with significant probably of detection, cheat the verifier. The verifiers may be selected by a third portion of the input batch as described, with random identities, and be paired with voter identities. The confirmation codes and random selections of digits may, for instance, be constructed by the election authority. As another example, a multiparty protocol may be employed, instead of using a single election authority, as has been mentioned and will be understood.

1. A method for randomly sampling votes from a relatively large population of persons comprising:
committing publicly to information based on first key information that will determine selected persons from first public random values, the first public random values to be realized later;
committing publicly to information based on second key information including for audit of ballot information and related tally information responsive to at least second public random values, the second public random values to be realized later;
providing ballot information, after the first public random values are realized, to the persons selected by the first public random values realized;
accepting and making public voted ballot information related to the ballot information provided at least to the selected persons;
making public a tabulation of the voted ballot information;
establishing, by revealing information related to the second key information, that the tally corresponds at least substantially with high probability to the voted ballot information; and
revealing the identity of selected persons after the vote information is accepted and made public.

2. The method of claim 1, further comprising:
receiving participation requests each related to a requesting person;
providing ballot information to the requesting persons;
accepting and making public voted ballot information related to the participation requesting ballots;
making public the tabulation that includes the votes related to ballots selected but does not include any votes related to participation requested ballots; and
such that the information supplied to and that made public related to requesting persons is substantially unrecognizable as to whether it is related to requesting persons or related to selected persons.

3. The method of claim 1, further comprising revealing the identity of requesting voters along with those of selected voters.

4. The method of claim 1, further comprising making the identity of the voters revealed public.

5. The method of claim 1, further comprising only revealing the identity of the voter to a verifier person also selected at random and making the identity of the verifier person public at least after the votes are cast.
